(19) United States
(12) Patent Application Publication
(10) Pub. No.: US 2008/0123218 A1
(43) Pub. Date: May 29, 2008

(54) Mobile Hard Disk

(75) Inventors: Chun-Ming Li, Taipei Hsien (TW); Yi-Wen Chou, Taipei Hsien (TW); Jian-Ming Sung, Tainan Hsien (TW); Shih-Yu Fang, Taipei Hsien (TW)

Correspondence Address: WPAT, PC;INTELLECTUAL PROPERTY ATTORNEYS, 2030 MAIN STREET, SUITE 1300, IRVINE, CA, 92614, US

(73) Assignee: CHENG UEI PRECISION INDUSTRY CO., LTD., Taipei Hsien (TW)

(21) Appl. No.: 11/563,348

(22) Filed: Nov. 27, 2006

(51) Int. Cl. G11B 33/12; G11B 33/14

(52) U.S. Cl. 360/97.01; 360/97.02

(57) ABSTRACT

A mobile hard disk, having a shield, a disk body having a front surface, an electric circuit board electrically connected to the disk body. The electric circuit board is parallel to and contacts with the front surface of the shield, wherein the electric circuit board and the disk body are both received in the shield. As the electric circuit board is parallel to and contacts with the front surface of the disk body, so the electric circuit board takes a little space of the shield, and the volume of the mobile hard disk is smaller than the traditional one.

### BACKGROUND OF THE INVENTION

1. Field of the Invention

The present invention relates to a mobile hard disk, and more particularly to a mobile hard disk which is convenient to take.

2. The Related Art

Computers become common in the world, as a result, many kinds of devices having different functions develop, For example, a mobile hard disk is connected to a computer for storing data. The mobile hard disk includes a disk body and a shield, the disk body is received in the shield. The disk body further comprises an electric circuit board for connecting the mobile hard disk to the computer. The electric circuit board of the traditional mobile hard disk is set on one side of the disk and is perpendicular to the front surface of the disk body. The electric circuit board is also received in the shield.

However, the electric circuit board of the traditional mobile hard disk is perpendicular to the front surface of the disk body and is received in the shield, a lot of space is required to receive the electric circuit board, so the volume of the mobile hard disk is large, it's inconvenient to take when using.

### SUMMARY OF THE INVENTION

Accordingly, an object of the present invention is to provide a mobile hard disk having a shield, a disk body having a front surface, an electric circuit board electrically connected to the disk body. The electric circuit board is parallel to and contacts with the front surface of the shield, wherein the electric circuit board and the disk body are both received in the shield.

As the electric circuit board is parallel to and contacts with the front surface of the disk body, so the electric circuit board takes a little space of the shield, and the volume of the mobile hard disk is smaller than the traditional one's, as a result, it's convenient to take the mobile hard disk, moreover, the cost of the mobile hard disk is decreased.

### BRIEF DESCRIPTION OF THE DRAWINGS

The present invention will be apparent to those skilled in the art by reading the following description of a preferred embodiment thereof, with reference to the attached drawings, in which:

FIG. 1 is an exploded view of a mobile hard disk of the present invention;

FIG. 2 is a perspective view of the mobile hard disk;

FIG. 3 is a perspective view of a disk body and an electric circuit board shown in FIG. 1;

FIG. 4 is an exploded view of another mobile hard disk; and

FIG. 5 is an assembled perspective view of FIG. 4.

### DETAILED DESCRIPTION OF THE PREFERRED EMBODIMENT

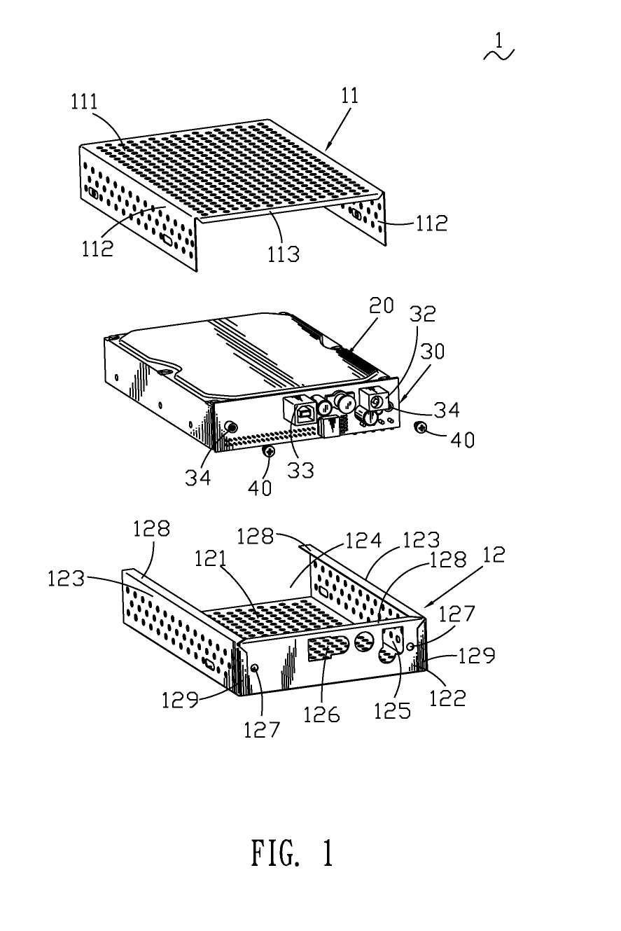

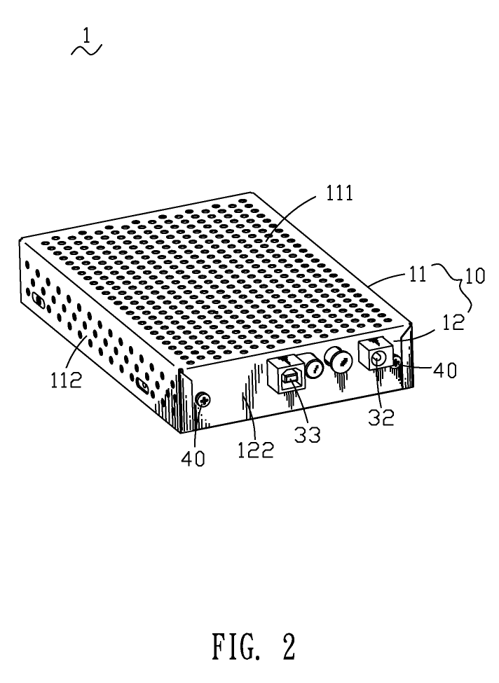

Please refer to FIG. 1 and FIG. 2, a mobile hard disk 1 of the present invention includes an upper shield 11, a disk body 20 and an electric circuit board 30. The upper shield 11 has a top plate 111, two opposite sides of the top plate 111 extend outward and then bend downward to form a pair of side plates 112. The lower shield 12 has a bottom wall 121, two opposite sides of the bottom wall 121 extend outward and then bend upward to form a pair of sidewalls 123. The front side of the bottom wall 121 extends outward and then bends upward to form a front wall 122, a first opening 125, a second opening 126 and a pair of holes 127 are opened in the front wall 122. A receiving space 124 is formed among the bottom wall 121, the front wall 122 and two sidewalls 123. The top of the front wall 122 and two sidewalls 123 extend horizontally towards the receiving space 124 to form a second stopping piece 128. The front side of the sidewall 123 extends forward and then bends toward the front wall 122 to form a third stopping piece 129 for contacting with the front wall 122.

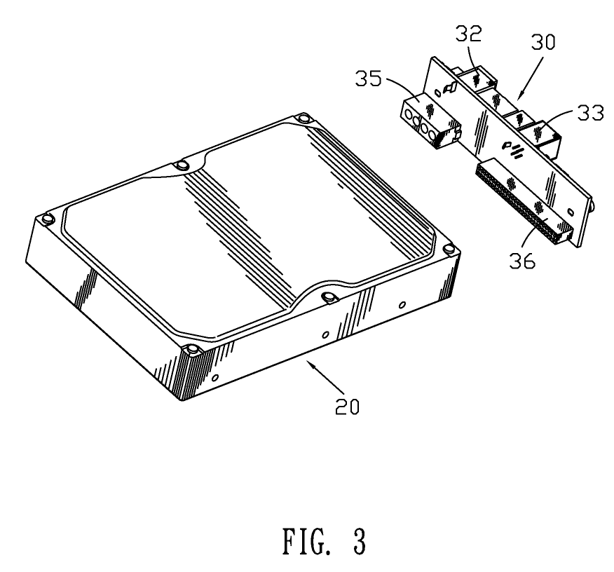

The disk body 20 is cuboid-shaped and has a front surface, the electric circuit board 30 is parallel and contact with the front surface. A power plug 32, a USB plug 33 and other electric circuit elements are mounted on the outer surface of the electric circuit board 30. The interface of the power plug 32 faces the front of the disk body 20 for connecting the mobile hard disk 1 to an outer power source (not shown) from the front. The interface of the USB plug 33 also faces the front of the disk body 20 for connecting the mobile hard disk 1 to a computer (not shown) from the front. The electric circuit board 30 further opens a pair of screw holes 34. Then please refer to FIG. 3, an interior power socket 35, a transmitting plug 36 and other elements are mounted on the inner surface of the electric circuit board 30. The power socket 35 connects power to the disk body 20, and the transmitting plug 36 connects to the disk body 20 for transmitting the data signal.

Referring to FIG. 1, when the mobile hard disk 1 is being assembled, both the power socket 35 and the transmitting plug 36 connect to the disk body 20, thereby, the electric circuit board 30 is connected to the disk body 20. Then, The disk body 20 and the electric circuit board 30 is inserted into the receiving space 124 from the back end of the lower shield 12, the second stopping piece 128 presses against the top of the disk body 20, the electric circuit board 30 contacts with the front wall of the lower shield 12, and the power plug 32 and the USB plug 33 passes through the first opening 125 and the second opening 126 respectively. Next, the upper shield 11 is covered on the lower shield 12, the side plates 112 of the upper shield 11 engage with the sidewalls 123 of the lower shield 12, the first stopping piece 113 contacts with the front wall 122, finally, a pair of screws 40 is inserted into the hole 127 of the lower shield 12 for securing the mobile hard disk 1, thus the mobile hard disk 1 is assembled.

In use, the power plug 32 is connected to the power source through a cable, the USB plug 33 is connected to the computer through another cable, then the mobile hard disk 1 is electrically connected to the computer, so the data is transmitting between the mobile hard disk 1 and the computer, the data is stored in the mobile hard disk 1.

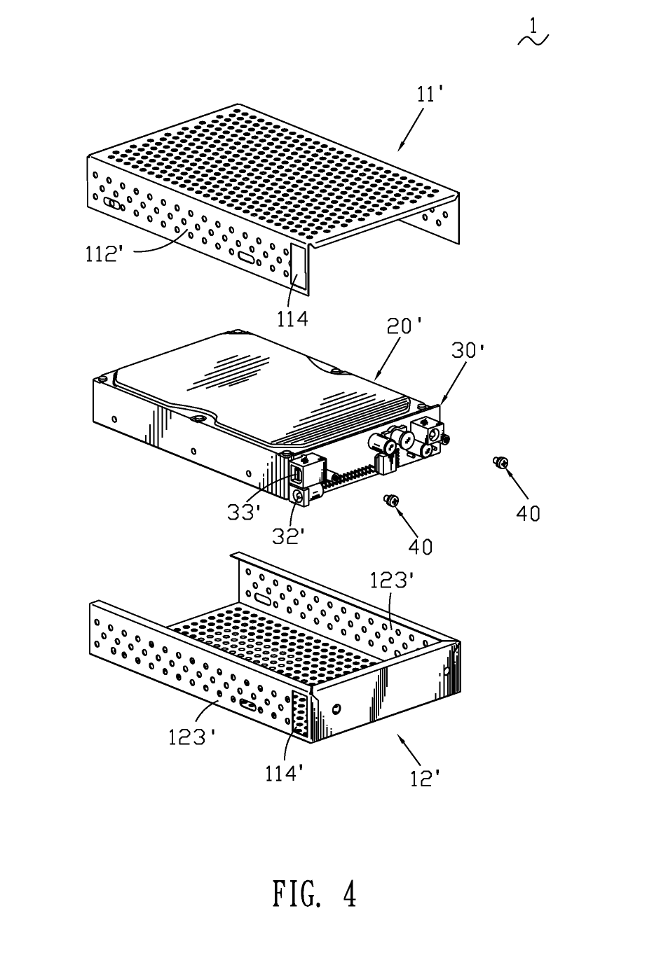

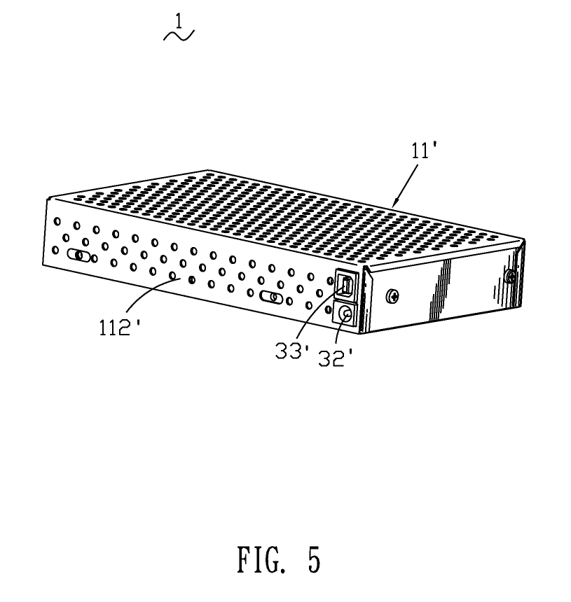

FIGS. 4-5 show another mobile hard disk 1′ having different structure. The power plug 32′ and the USB plug 33′ are both set on the edge of the electric circuit board 30′ with the interfaces facing the side of the disk body 20′. Accordingly, an third opening 114 is opened in the side plate 112′ of the upper shield 11′, and a forth opening 114′ is opened in the sidewall 122′ of the lower shield 12′ for allowing the power plug 32′ and the USB plug 33′ passing through. As a result, the mobile hard disk 1′ is connected to other devices from the side of the mobile hard disk 1′.

As described above, the electric circuit boards 30, 30′ are parallel to and contact with the front surfaces of the disk bodiess 20, 20′, so the electric circuit boards 30, 30′ take a little space of the shield 10, and the volume of the mobile hard disks 1, 1′ is smaller than the traditional one's, as a result, it's convenient to take the mobile hard disks 1, 1′, moreover, the cost of the mobile hard disks 1, 1′ is decreased.

The foregoing description of the present invention has been presented for purposes of illustration and description. It is not intended to be exhaustive or to limit the invention to the precise form disclosed, and obviously many modifications and variations are possible in light of the above teaching. Such modifications and variations that may be apparent to those skilled in the art are intended to be included within the scope of this invention as defined by the accompanying claims.

What is claimed is:

1. A mobile hard disk, comprising:
a shield;
a disk body having a front surface;
an electric circuit board electrically connected to the disk body, the electric circuit board being parallel to and contacting with the front surface of the shield,
wherein the electric circuit board and the disk body are both received in the shield.

2. The mobile hard disk as claimed in claim 1, further comprising a power plug, a USB plug and other electric circuit elements mounted on the outer surface of the electric circuit board, and at least one opening opened in the shield for allowing the power plug and the USB plug passing through, and a power socket, a transmitting plug and other electric elements mounted on the inner surface of the electric circuit board.

3. The mobile hard disk as claimed in claim 2, wherein the power plug and the USB plug are mounted on the outer surface of the electric circuit board with the interface facing the front of the disk body, accordingly, the opening is opened in the front of the shield.

4. The mobile hard disk as claimed in claim 2, wherein the power plug and the USB plug are mounted on the outer surface of the electric circuit board with the interface facing the side of the disk body, accordingly, the opening is opened in the side of the shield.

5. The mobile hard disk as claimed in claim 1, wherein the shield includes an upper shield and a lower shield, the upper shield having a top plate and a pair of side plate, the lower shield having a bottom wall and a pair of sidewalls, a receiving space being formed therebetween, the upper shield covered on the lower shield with the side plates engaging with the sidewalls.
